(19) United States
(12) Patent Application Publication
(10) Pub. No.: US 2006/0129813 A1
(43) Pub. Date: Jun. 15, 2006

(54) Methods of authenticating electronic devices in mobile networks

(76) Inventors: Vidya Narayanan, Schaumburg, IL (US); George Popovich, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/013,049

(22) Filed: Dec. 15, 2004

(51) Int. Cl. H04L 9/00

(52) U.S. Cl. 713/168

(57) ABSTRACT

The present invention relates to methods of authenticating an electronic device in a mobile network. A method of authenticating an electronic device comprises a first mobile network controller receiving an authentication request from the electronic device in a mobile network 105; searching for an authentication credential 110 at a first mobile network controller by searching in a local database of the first mobile network controller; and, searching for an alternate authentication server to fulfill the authentication request 115, if the authentication credential is not found in the local database of the first mobile network controller.

### FIELD OF THE INVENTION

The present invention relates generally to mobile networks and more particularly, to the field of authentication of electronic devices in mobile networks.

### BACKGROUND OF THE INVENTION

Electronic devices in mobile networks need to be authenticated to the network infrastructure. At present, electronic devices are generally authenticated via a mobile network controller (also known as a mobile router) at a Customer Enterprise Network (CEN) where the CEN hosts an Authentication Authorization and Accounting (AAA) server and provides authentication of the electronic devices. However, this is possible only if the mobile network controller (MNC) has connectivity to the CEN.

At present, the known methods of authenticating electronic devices when there is no connectivity to the CEN are ineffective. One method of authenticating electronic devices when there is no connectivity to the CEN is to mirror or copy an entire AAA server and place it in a location that the electronic device can receive authentication services such as in a vehicle near the electronic device. However, providing an entire AAA server by mirroring the entire AAA database in a vehicle to address the current problem of authentication when there is no connectivity to the CEN is not a feasible solution. From a cost standpoint, it is not possible for vehicles to possess entire AAA servers. Further, a compromised vehicle would mean an entire AAA database may be compromised. This would force users and electronic devices to be given new credentials whenever a vehicle or a mobile router is compromised. This would greatly increase the time and effort required to recreate the database every time a vehicle is compromised. Most importantly, from a security standpoint, an entire network comprising of a possibly large number of mobile devices and mobile networks, is vulnerable when an AAA database is comprised.

A second method of authenticating electronic devices when there is no connectivity to the CEN is to use a RADIUS (remote authentication dial-in user service) proxy which enables an intermediate server to act as a RADIUS client for all electronic devices. However, the RADIUS proxy has several disadvantages. A box only acts either as a proxy or a server at any given time. Further, the RADIUS method does not address the problem of dynamically changing the authentication server, depending on the local availability of credentials. Accordingly, there exists a need for a solution that addresses the shortcomings of these methods.

### BRIEF DESCRIPTION OF THE DRAWINGS

FIG. 1 is a flow chart depicting a method of authenticating an electronic device behind a mobile router or a mobile network controller.

FIG. 2 is a flow chart depicting an embodiment of the invention, for authenticating an electronic device.

FIG. 3 is a flow chart depicting another embodiment of the invention for authenticating an electronic device by scanning for neighboring mobile network controllers.

FIG. 4 is a flow chart of an embodiment of the invention for authenticating an electronic device by scanning for neighboring mobile network controllers.

FIG. 5 is a flow chart of another embodiment of the invention for authenticating an electronic device using a second mobile network controller.

FIG. 6 is a schematic diagram depicting another embodiment of the invention for authenticating an electronic device.

FIG. 7 is a schematic diagram depicting another embodiment of the invention for authenticating an electronic device.

FIG. 8 is a schematic diagram depicting another embodiment of the invention for authenticating an electronic device.

### DETAILED DESCRIPTION

Before describing in detail authentication in accordance with the present invention, it should be observed that the present invention resides primarily in combinations of method steps and apparatus components related to authentication. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

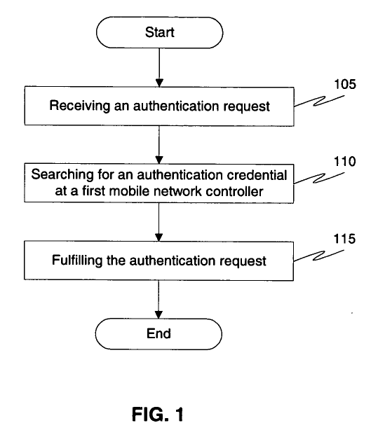

Methods for authenticating an electronic device in a mobile network are disclosed. According to FIG. 1, an embodiment of the invention comprises receiving an authentication request from an electronic device in a mobile network 105, searching for an authentication credential at a first mobile network controller (MNC) 110 (as used herein, also known as a mobile router); and fulfilling the authentication request 115. As used herein and as known in the art, a mobile network is one or more IP subnets served by a MNC where served by means that communications are facilitated by and routed through the MNC. A mobile network changes its point of attachment to the rest of the network along with the MNC. The MNC is a device that performs the functionality of a mobile router in addition to providing authentication for electronic devices attached to its mobile network(s). Further, the MNC facilitates communications between electronic devices attached to its mobile network(s) whether the electronic devices have connectivity to a network infrastructure or not. In many embodiments, the MNC also has the ability to query other MNCs that may be present in neighboring geographical areas.

As used herein, an electronic device may be any suitable type of wireless communications device capable of communicating with other electronic devices, for instance, a laptop computer, a personal digital assistant, a voice handset, or any other suitable device as will be appreciated by those of skill in the art. Further, the electronic device may be one of a local node, and a visiting node. An electronic device is a local node for a given MNC if it has its “home network” (known in the art as the network from which the permanent IP address of the electronic device is obtained) on the mobile network served by that MNC. An electronic device is a visiting node for that MNC when it does not have its home on that mobile network.

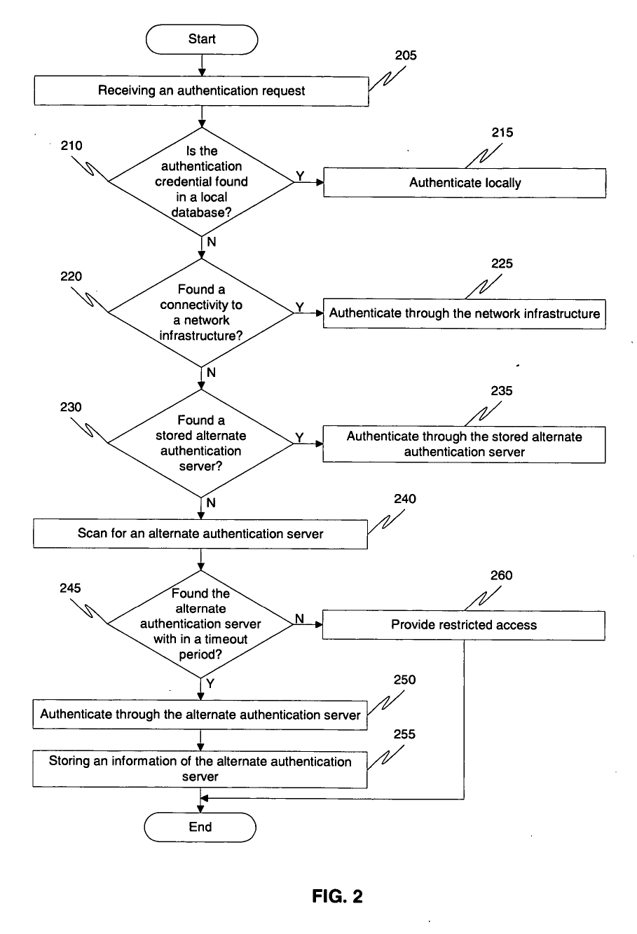

Upon sending the authentication request, a search for the authentication credential to validate the electronic device is made. In one embodiment, the authentication credential can be one of a device ID, password, and encrypted key. As is known to one of ordinary skill in the art, other types of authentication credentials may be used. The electronic device may be seeking authentication to the MNC. An electronic device can also send the authentication request through an access point on a subnet where the access point co-located with the MNC on the subnet will forward the authentication request to the MNC. According to another embodiment of the invention as shown in FIG. 2, if the authentication credential is found in a local database 210 at the first MNC, the electronic device is authenticated at the first MNC 215. The local database may comprise of authentication credentials for the local nodes.

According to another embodiment of the invention, if the authentication credential is not found in the local database, the first MNC searches for connectivity to a network infrastructure 220. The network infrastructure comprises one of a Customer Enterprise Network (CEN), Authentication Authorization and Accounting (AAA) server or the like. According to another embodiment of the invention, if connectivity is found 220, the first MNC fulfills the authentication request by authenticating the electronic device using the network infrastructure 225. The electronic device may be authenticated by validating relevant authentication credentials of the electronic device at the network infrastructure. The local database at the first MNC is updated periodically, whenever connectivity to the CEN is established and there are changes in authentication credentials. There may be other ways of updating the local database as well, for instance, the AAA server in the CEN proactively pushing changes in the authentication credentials to the first MNC. Alternatively, the CEN may periodically contact the first MNC to update the local database with authentication credentials. When an electronic device behind a first MNC comes in the realm of a different mobile network, the electronic device becomes a visiting node. As used herein, for an electronic device to be “behind” an MNC means to be on the mobile network served by the MNC. The first MNC may not be able to authenticate the electronic device on the mobile network from its local database. In case of a failure of the first MNC to connect to the CEN, the visiting mobile node will not be authenticated by the local database stored in a first MNC because the visiting mobile node is not normally found at this MNC and the local database does not have the authentication credentials for the visiting mobile node. A second MNC may have credentials to authenticate this visiting mobile node. For example, a particular visiting mobile node located at a vehicle can be a home mobile node at another vehicle.

According to another embodiment of the invention, if connectivity is not found, the first MNC searches for a stored alternate authentication server 230. The stored alternate authentication server may be found at the first MNC. The stored alternate authentication server may be another MNC through which the visiting node was authenticated earlier. In another embodiment of the invention, if the stored alternate authentication server is present, the electronic device is authenticated through the stored alternate authentication server 235.

Pursuant to another embodiment of the invention, if the stored alternate authentication server is not present, the first MNC searches for an alternate authentication server 240. The alternate authentication server may be present at another MNC. The first MNC maintains a list of unique identifiers for each of the MNCs found in the search. Upon finding the alternate authentication server 245, the electronic device is authenticated through the alternate authentication server 250. Protected authentication credentials are used in authenticating the electronic device. Encryption is one way of protecting authentication credentials. After authentication, the information of the alternate authentication server is stored 255 at the first MNC. The particular alternate authentication server now gets stored at the first MNC to become a “stored alternate authentication server.” This is done to handle future authentication requests.

According to another embodiment of the invention, if the alternate authentication server is not found, restricted access is provided to the electronic device 260. In the case where the electronic device is responsible for sending the authentication request through an access point, the access point may send a RADIUS message to the MNC for authenticating the device.

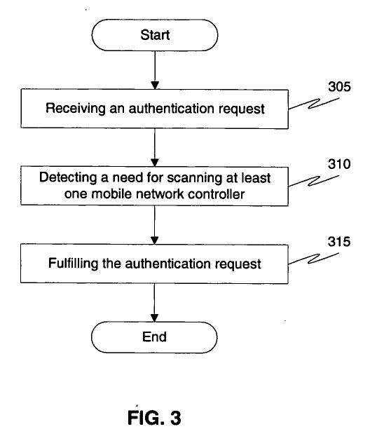

According to FIG. 3, another embodiment of the invention comprises receiving a query for an authentication request 305 from an electronic device in a mobile network, detecting a need for scanning the mobile network for at least one mobile network controller 310, and fulfilling the authentication request 315.

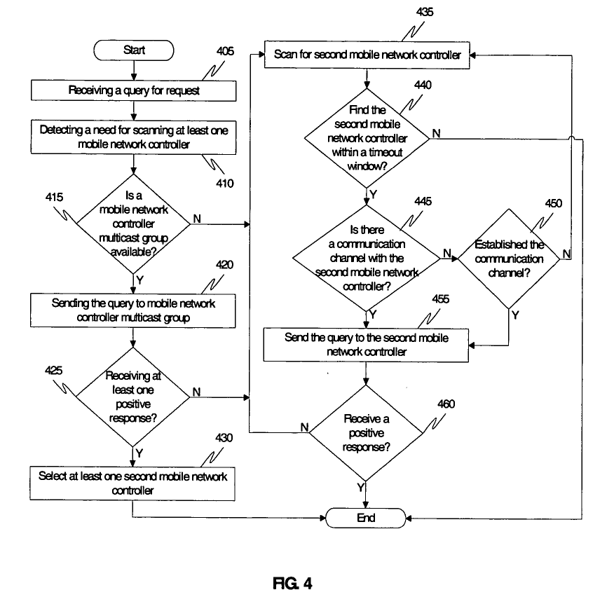

According to FIG. 4, another embodiment of the invention comprises a first mobile network controller receiving a query for an authentication request from an electronic device in a mobile network 405. Upon receiving the query, a determination of a need for scanning the mobile network for neighboring MNCs is made 410. The MNC scans for another neighboring MNC for handling the authentication request. According to an embodiment, the need for scanning is first determined by searching for an authentication credential in a local database of the first MNC. Furthermore, a search for connectivity to a network infrastructure is made, if the authentication credential is not found in the local database. Lastly, a search for a stored alternate authentication server at the first MNC is made, if connectivity to the network infrastructure is absent.

Once the need for scanning is established, another embodiment of the invention further comprises searching for at least one MNC multicast group 415. The MNC multicast group is allocated for authentication message exchanges among a number of MNC that have subscribed to the group. If the MNC multicast group is available, the query is sent to the MNC multicast group 420. The query is sent along with a list of the MNCs scanned and a unique identifier of the electronic device. Upon sending the query, if at least one positive response is received from the MNC multicast group 425, at least one second MNC is selected 430 from the MNC multicast group. The selection of the second MNC is followed by a scan for an alternate authentication server 465 at the second MNC.

According to another embodiment of the invention, if there is no positive response from the MNC multicast group, a scan for a second MNC is made 435. If the second MNC is found within a timeout window 440, a determination is made of whether there is a secure communication channel between the first MNC and the second MNC 445. The existence of a secure communication channel may be determined by a number of means including the availability of a shared key between the first MNC and the second MNC, the existence of a peer-to-peer virtual private network, and a number of other well-known secure methods. If such a secure communication channel does not exist, the communication channel is established 450 and the query is then sent to the second MNC. To establish a secure communications channel, as per one embodiment of the invention, the first MNC may create a shared key with the second MNC and by doing so establishes a secure communication channel with the second MNC. The query is sent to the second MNC 455 with a unique identifier of the electronic device. If an affirmative response is received from the second MNC 460, the electronic device is authenticated.

According to another embodiment of the invention, if the MNC multicast group is not available, a scan for a second MNC is made 435. If the second MNC is found within a timeout window 440, a determination is made of whether there is a secure communication channel between the first MNC and the second MNC 445. If the secure communication channel does not exist, the communication channel is established 450 and the query is then sent to the second MNC. The query is sent to the second MNC 455 with a unique identifier of the electronic device. If an affirmative response is received from the second MNC 460, the electronic device is authenticated.

According to another embodiment of the invention, if the second MNC is not found within a timeout window 440, restricted access is provided to the electronic device, similar to 260.

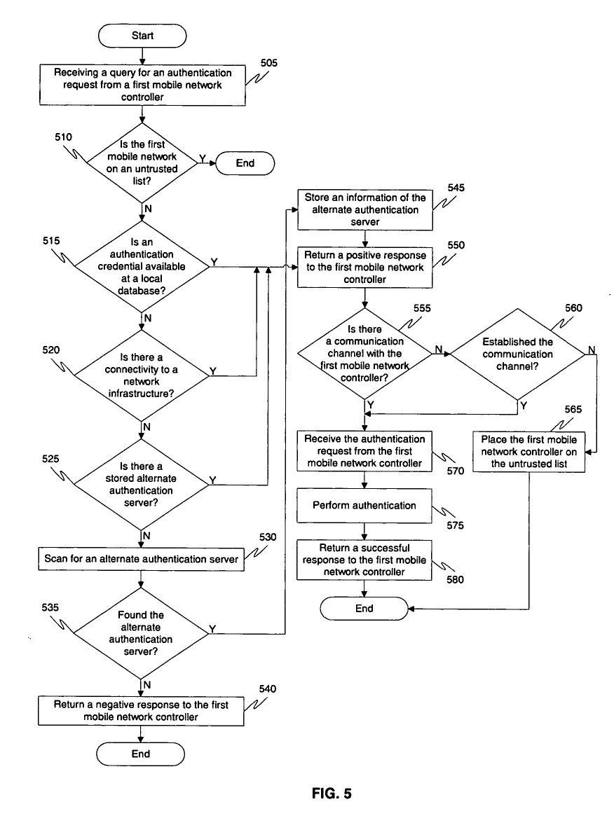

According to FIG. 5, another embodiment of the invention comprises a second MNC receiving a query for an authentication request of an electronic device from a first MNC 505. Upon receiving the query, a determination is made whether the first MNC is included in an untrusted list 510. The untrusted list is maintained by the second MNC and includes MNCs, which have not been able to establish a secure communication channel for exchanging authentication messages with the second MNC. Upon making a determination regarding the untrusted list, the authentication request is fulfilled.

According to an embodiment of the invention, if the first MNC is included in the untrusted list 510, the query is denied and a negative response is returned to the first MNC.

According to another embodiment of the invention, if the first MNC is not included in the untrusted list 510, a search is made for an authentication credential at a local database on the second MNC 515. According to another embodiment, if the authentication credential is found on the local database, a positive response is returned to the first MNC 550. Next, a determination is made whether there exists a communication channel with the first MNC, for a secure exchange of authentication messages. If the communication channel already exists 560, the authentication request is received from the first MNC 570. The electronic device is authenticated 575 and a successful response is returned to the first MNC 580. Authentication credentials encrypted with shared keys may be used in authenticating the electronic device. If the communication channel does not exist, the communication channel is established first 560, and authentication 575 follows the establishment of the communication channel. If the communication channel cannot be established, the first MNC is placed on the untrusted list 565.

According to another embodiment of the invention, if the authentication credential is not found, a search is made to find connectivity to a network infrastructure 520. If the connectivity is found, a positive response is returned to the first MNC 550, and the similar process as described in the embodiment above regarding authenticating the electronic device follows. The local database at the first MNC is updated periodically, whenever the connectivity to the CEN is established. Also, the CEN may periodically contact the first MNC to update the local database with authentication credentials.

According to another embodiment of the invention, if the connectivity is absent, a search is made for an alternate authentication server 530. If the alternate authentication server is found within a timeout period 535, information pertaining to the alternate authentication server is stored at the second MNC 545. Upon storing the information, a positive response is returned to the first MNC 550. Next, a determination is made whether there is a communication channel with the first MNC to ensure secure exchange of authentication messages. If the communication channel exists 555, the authentication request is received from the first MNC 570, the device is authenticated 575 and a successful response is returned to the first MNC 580. Authentication credentials encrypted with shared keys are used in authenticating the electronic device. According to another embodiment of the invention, if the communication channel does not exist, an attempt is made to establish the communication channel 560. If the communication channel can be established, the authentication request is received from the first MNC 570, the device is authenticated 575 and a successful response is returned to the first MNC 580. According to another embodiment of the invention, if the communication channel cannot be established, the first MNC is placed on the untrusted list 565.

According to another embodiment of the invention, if the alternate authentication server is not found, a negative response is returned to the first MNC 540, and the authentication is denied. Further, an authentication failure would also be indicated when the authentication credentials do not successfully authenticate.

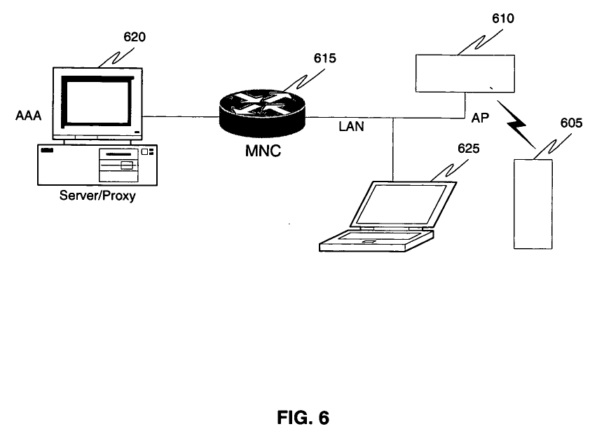

FIG. 6 is a block diagram of an embodiment of the invention. According to FIG. 6, an electronic device 605 in a mobile network sends an authentication request through an access point 610 to a first MNC 615. The first MNC 615 is communicating in a wireless mode to the access point 610. Another mobile device 625 can also communicate the authentication request to the MNC using a Local Area Network (LAN) without routing the request through the access point 610. A search for an authentication credential is made at a local database at the first MNC. If the authentication credential is not found, the first MNC finds connectivity to a network infrastructure such as the CEN 620. If the connectivity is found, the device is authenticated at the CEN using the AAA server.

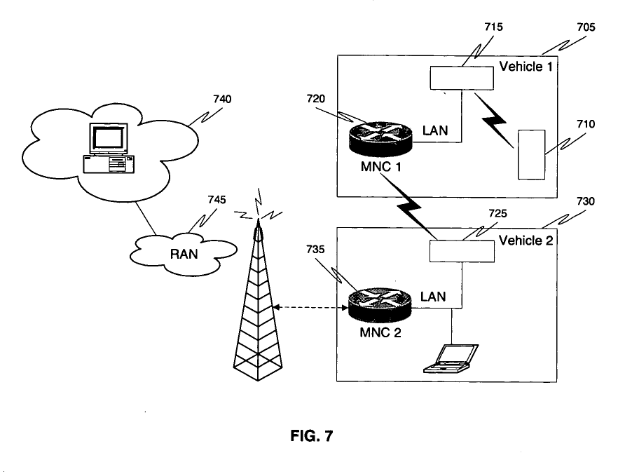

FIG. 7 is a block diagram of an embodiment of the invention. According to FIG. 7, a first electronic device 710 in a first vehicle 705 sends an authentication request to a first MNC 720. This request is either sent directly by the electronic device 710 or is sent through a first access point 715 located in the first vehicle 705. The first MNC 720 may search for an alternate authentication server by contacting a second MNC 735 through a second access point 725 in a second vehicle 730. Alternatively, the second MNC 735 may handle the authentication request by finding connectivity to a network infrastructure 740 having a CEN. The MNCs find connectivity to the CEN through a Radio Access Network (RAN) 745. This connection with the CEN enables the MNCs to authenticate the electronic device 710 through the AAA server available at the CEN.

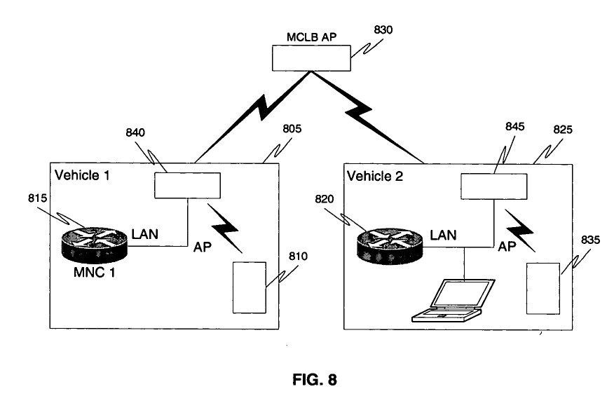

FIG. 8 is a schematic diagram of another embodiment of the invention. According to FIG. 8, a first electronic device 810 in a first vehicle 805 sends an authentication request to the first MNC 815 through an access point 840. The first MNC 815 communicates with the access point 840 in a wireless mode. When the first MNC 815 attempts to scan for a neighboring MNC such as a second MNC 820 in a second vehicle 825, the authentication request may be handled by a predetermined access point 830. Similarly, a second mobile device 835 in a second vehicle 825 can send an authentication request to the second MNC 820 through an access point 845. In one embodiment, the same procedure as described with the first MNC 815 will be carried out with a third MNC (not shown in the diagram) in a third vehicle (not shown in the diagram) to fulfill an authentication request. Such large-scale incidents can be handled via the access point. The access point allows the first MNC 815 and the second MNC 820 or other MNCs to communicate amongst each other.

It will be appreciated the authentication described herein may be comprised of one or more conventional processors and unique stored program instructions that control the one or more processors to implement, in conjunction with certain non-processor circuits, some, most, or all of the functions of the authentication described herein. The non-processor circuits may include, but are not limited to, a radio receiver, a radio transmitter, signal drivers, clock circuits, power source circuits, and user input devices. As such, these functions may be interpreted as steps of a method to perform authentication. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of authenticating an electronic device, the method comprising steps of:
receiving an authentication request from the electronic device in a mobile network;
searching for an authentication credential at a first mobile network controller by searching in a local database of the first mobile network controller; and
searching for an alternate authentication server to fulfill the authentication request, if the authentication credential is not found in the local database of the first mobile network controller.

2. The method of claim 1 wherein the searching for an alternate authentication server step further comprises:
the first mobile network controller finding connectivity to a network infrastructure.

3. The method of claim 1 wherein the alternate authentication server is stored.

4. The method of claim 1 wherein the searching for an alternate authentication server step further comprises:
scanning for an alternate authentication server in other mobile networks.

5. The method of claim 4, wherein the authentication request is fulfilled by providing restricted access to the electronic device.

6. The method of claim 4, further comprising:
storing an information about the alternate authentication server in the first mobile network controller.

7. A method of authenticating an electronic device, the method comprising steps of:
receiving a query for an authentication request from the electronic device in a mobile network;
detecting a need for scanning at least one mobile network controller in the mobile network; and,
fulfilling the authentication request.

8. The method of claim 7 wherein the step of detecting further comprises:
searching for an authentication credential at a first mobile network controller by searching in a local database of the first mobile network controller;
if the authentication credential is not found in the local database, then
finding a connectivity to a network infrastructure,
searching for a stored alternate authentication server at the first mobile network controller; and
searching for at least one mobile network controller multicast group.

9. The method of claim 8, further comprising:
finding a second mobile network controller within a timeout window;
determining whether there is a secure communication channel with the second mobile network controller; and
sending the query to the second mobile network controller, if the secure communication channel exists;
receiving an affirmative response from the second mobile network controller.

10. The method of claim 8, wherein the fulfilling step further comprises:
sending the query to the mobile network controller multicast group.

11. The method of claim 10, wherein the fulfilling step further comprises:
receiving at least one positive response for the query sent to the mobile network controller multicast group; and
selecting at least one mobile network controller from a response received from the mobile network controller multicast group.

12. The method of claim 10, further comprising:
finding a second mobile network controller within a timeout window;
determining whether there is a secure communication channel with the second mobile network controller;
sending the query to the second mobile network controller, if the secure communication channel exists;
receiving an affirmative response from the second mobile network controller.

13. The method of claim 11 further comprising the step of:
providing restricted access to the electronic device, if an alternate authentication server is not found within the timeout period.

14. The method of claim 11, further comprising the step of storing an information about an alternate authentication server in the first mobile network controller.

15. A method of authenticating an electronic device, the method comprising steps of:
at a second mobile network controller:
receiving a query for an authentication request for the electronic device in a mobile network from a first mobile network controller;
determining whether the first mobile network controller is included in an untrusted list; and,
fulfilling the authentication request.

16. The method of claim of 15, wherein the fulfilling step further comprises:
returning a negative response to the first mobile network controller, if the first mobile network controller is included in the untrusted list.

17. The method of claim 16, wherein the fulfilling step further comprises:
searching for an authentication credential in a local database;
returning a positive response to the first mobile network controller, if the authentication credential is found in the local database;
determining whether there exists a communication channel with the first mobile network controller;
receiving the authentication request from the first mobile network controller, if the communication channel exists;
performing authentication; and,
returning a successful result to the first mobile network controller.

18. The method of claim 16, wherein the fulfilling step further comprises:
searching for an authentication credential in a local database;
returning a positive response to the first mobile network controller, if the authentication credential is found;
determining whether there is a communication channel with the first mobile network controller;
attempting to establish a communication channel with the first mobile network controller, if the communication channel does not exist; and,
placing the first mobile network controller on the untrusted list, if unable to establish the communication channel.

19. The method of claim 16, wherein the fulfilling step further comprises:
finding connectivity to a network infrastructure;
returning a positive response to the first mobile network controller, if the connectivity is found;
determining whether there is a communication channel with the first mobile network controller;
receiving the authentication request from the first mobile network controller, if the communication channel exists;
performing authentication; and,
returning a successful result to the first mobile network controller.

20. The method of claim 16, wherein the fulfilling step further comprises:
finding an alternate authentication server;
storing an information of the alternate authentication server, if the alternate authentication server is found within a timeout period;
returning a positive response to the first mobile network controller;
determining whether there is a communication channel with the first mobile network controller;
receiving the authentication request from the first mobile network controller, if the communication channel exists;
performing authentication; and,
returning a successful response to the first mobile network controller.
